(19) United States
(12) Patent Application Publication
(10) Pub. No.: US 2023/0067078 A1
(43) Pub. Date: Mar. 2, 2023

(54) WEAR BLOCK ASSEMBLY FOR A THREE-POINT HITCH

(71) Applicant: CNH INDUSTRIAL AMERICA LLC, New Holland, PA (US)

(72) Inventors: Chad Sietsema, Moorhead, MN (US); John T. Rasset, Barnesville, MN (US); Thomas Michael Curley, Fargo, ND (US)

(21) Appl. No.: 17/463,198

(22) Filed: Aug. 31, 2021

(51) Int. Cl. A01B 59/00

(52) U.S. Cl. CPC A01B 59/002; A01B 59/066

(57) ABSTRACT

A wear block assembly for a three-point hitch includes an actuator wedge that moves along a longitudinal axis relative to a lower lift arm of the three-point hitch. The actuator wedge also includes a tapered surface. The wear block assembly also includes a wear block that moves along a lateral axis relative to the lower lift arm and the wear block includes a wear surface that engages a sway block of the three-point hitch. The wear block also includes a contact surface that engages the tapered surface of the actuator wedge. The actuator wedge drives the wear block to move in a first direction along the lateral axis in response to movement of the actuator wedge in a second direction along the longitudinal axis.

### BACKGROUND

The present disclosure relates generally to a wear block assembly for a three-point hitch.

Certain work vehicles, such as tractors, include a three-point hitch configured to engage a corresponding hitch of a towed implement. Certain three-point hitches include two lower lift arms and an upper link. Each lower lift arm includes an opening configured to receive a corresponding lower hitch pin of the towed implement hitch, and the upper link includes an opening configured to receive a corresponding upper hitch pin of the towed implement hitch. Each hitch pin may be disposed within a corresponding opening to couple the towed implement to the work vehicle.

The three-point hitch may enable lateral movement or sway of the towed implement hitch to provide the towed implement with additional freedom of movement. The amount of sway sufficient to facilitate effective functioning of the towed implement may vary. In order to reduce or limit unwanted lateral movement of the towed implement hitch, at least one lower lift arm of the three-point hitch may couple to a wear block configured to engage a portion of the three-point hitch (e.g., a respective sway block) to substantially block lateral movement of the lower lift arm. The wear block may provide a designated surface for wear. For example, the wear block may wear in response to contact with the portion of the three-point hitch (e.g., the respective sway block) as the lower lift arms are repeatedly raised and lowered and/or as the lower lift arms move in response to the sway. Wear blocks may be repeatedly adjusted due to wearing of the wear blocks. The process of adjusting the wear blocks may include removal of the wear blocks and installation of one or more shims. Unfortunately, the shim installation process may be significantly time-consuming, thereby reducing the efficiency of agricultural operations.

### BRIEF DESCRIPTION

In certain embodiments, a wear block assembly for a three-point hitch includes an actuator wedge that moves along a longitudinal axis relative to a lower lift arm of the three-point hitch. The actuator wedge also includes a tapered surface. The wear block assembly also includes a wear block that moves along a lateral axis relative to the lower lift arm and the wear block includes a wear surface that engages a sway block of the three-point hitch. The wear block also includes a contact surface that engages the tapered surface of the actuator wedge. The actuator wedge drives the wear block to move in a first direction along the lateral axis in response to movement of the actuator wedge in a second direction along the longitudinal axis.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle coupled to an implement via a three-point hitch;

FIG. 2 is a front perspective view of an embodiment of the three-point hitch of FIG. 1 including a wear block assembly;

FIG. 3 is a perspective view of a lower lift arm and the wear block assembly of the three-point hitch of FIG. 2;

FIG. 4 is a cross-sectional view of the lower lift arm and the wear block assembly of FIG. 3;

FIG. 5A is a top perspective view of a wear block of the wear block assembly of FIG. 2;

FIG. 5B is a bottom perspective view of the wear block of FIG. 5A;

FIG. 6A is a top perspective view of an actuator wedge of the wear block assembly of FIG. 2; and

FIG. 6B is a rear perspective view of the actuator wedge of FIG. 6A.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. As used herein, “sway distance” is a distance between a wear block and a respective sway block that enables a corresponding lower lift arm (e.g., and the corresponding towed implement) to move laterally.

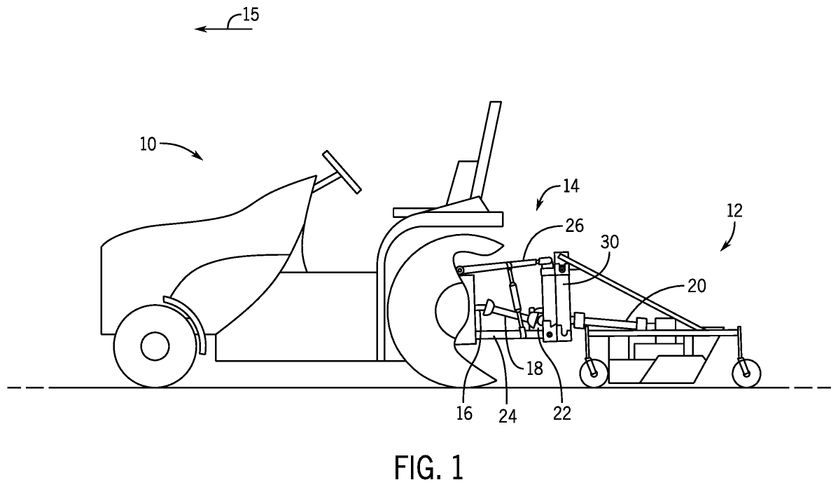

FIG. 1 is a side view of an embodiment of a work vehicle 10 coupled to an implement 12 via a three-point hitch 14. The work vehicle 10 is configured to tow the implement 12 (e.g., through a field) along a direction of travel 15. In the illustrated embodiment, the work vehicle 10 is a tractor. However, in other embodiments, the work vehicle may be any other suitable type of work vehicle configured to tow an implement, such as a harvester or a sprayer. Furthermore, in the illustrated embodiment, the implement 12 is a powered implement, such as a spreader, a rotary mower, or a rotary tiller. The implement is powered by a power-take off (PTO) shaft 16 of the work vehicle 10. An engine of the work vehicle 10 drives the PTO shaft to rotate (e.g., via a transmission, a PTO drive system, etc.), and rotation of the PTO shaft drives rotation of one or more rotary components of the implement 12, such as a rotary spreader system, mower blades, or a rotary tillage assembly. In the illustrated embodiment, the PTO shaft 16 includes a telescoping portion 18 configured to facilitate adjustment of a length of the PTO shaft 16 to accommodate different types of powered implements. However, in other embodiments, the work vehicle may have a non-telescoping PTO shaft. As illustrated, the PTO shaft 16 of the work vehicle 10 is coupled to a corresponding shaft 20 of the implement 12, and the corresponding shaft 20 of the implement 12 is configured to drive rotation of the rotary component(s) of the implement 12. The PTO shaft 16 and the corresponding shaft 20 of the implement 12 are coupled to one another via a connection assembly 22. The connection assembly 22 may include any suitable device(s) configured to couple the PTO shaft 16 to the corresponding shaft 20, such that rotation of the PTO shaft 16 drives the corresponding shaft 20 to rotate. While the implement 12 is a powered implement in the illustrated embodiment, in other embodiments, the implement may be a non-powered implement, such as a vertical tillage implement, a primary tillage implement, a seeding implement, or a finishing implement. In such embodiments, the PTO shaft of the work vehicle may not be coupled to a corresponding shaft of the implement, or the work vehicle may not include a PTO shaft.

In the illustrated embodiment, the implement 12 is coupled to the work vehicle 10 via the three-point hitch 14 of the work vehicle 10. The three-point hitch 14 includes two lower lift arms 24 and an upper link 26. The two lower lift arms 24 and the upper link 26 are coupled (e.g., rotatably coupled) to a chassis of the work vehicle 10. In certain embodiments, one or more actuators are coupled to the lower lift arms and configured to drive the lower lift arms to rotate relative to the chassis of the work vehicle. Each lower lift arm 24 includes an opening configured to receive a corresponding lower hitch pin of the implement 12, and the upper link 26 includes an opening configured to receive a corresponding upper hitch pin of the implement 12. In certain embodiments, each hitch pin of the implement 12 may be disposed within a corresponding opening to couple the implement 12 to the work vehicle 10.

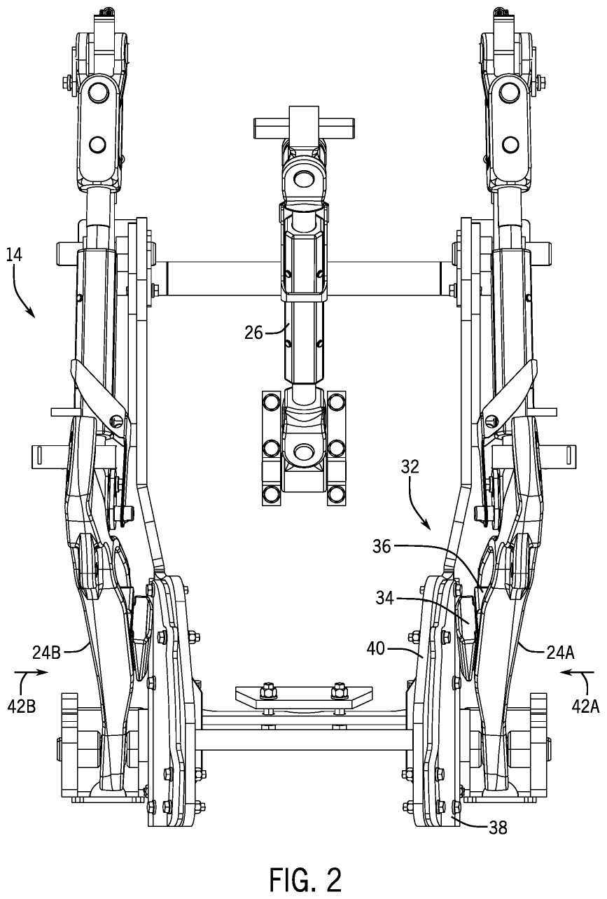

FIG. 2 is a front perspective view of an embodiment of the three-point hitch 14 of FIG. 1 including a wear block assembly 32. In the illustrated embodiment, the wear block assembly 32 is coupled to a first lower lift arm 24A. The wear block assembly 32 includes a wear block 34 and an actuator wedge 36. The wear block 34 is configured to engage a sway block 38, which is coupled to a frame 40 of the three-point hitch 14. During engagement with the sway block 38, the wear block 34 may reduce or substantially block lateral movement (e.g., sway) of the lower lift arms 24A, 24B in a first lateral direction 42A. The actuator wedge 36 may enable continuous or incremental adjustment of the wear block 34 to accommodate a number of sway distances. For example, during a transport mode, the lower lift arms 24A, 24B may be raised up to lift a towed implement off the ground. In the transport mode, the wear block 34 may be adjusted to reduce lateral movement in the first lateral direction 42A or to substantially block lateral movement in the first lateral direction 42B of the lower lift arms 24A, 24B/implement hitch. During such transport, the user may set the wear block 34 to establish reduced or substantially no sway. For example, the wear block 34 may be moved into engagement with the sway block 38, and the engagement with the sway block 38 may substantially block movement in the first lateral direction 42A of the lower lift arms 24A, 24B of the three-point hitch 14. Accordingly, the engagement of the wear block 34 with the sway block 38 may reduce or substantially block lateral movement in the first lateral direction 42A of the towed implement during transport.

Additionally or alternatively, the three-point hitch 14 may include a second lower lift arm 24B having a corresponding wear block assembly coupled to the second lower lift arm 24B and the corresponding wear block assembly may be similar to the wear block assembly 32. For example, the second wear block assembly may include a wear block and an actuator wedge. The wear block assembly of the second lower lift arm 24B may reduce or substantially block lateral movement (e.g., sway) of the lower lift arms 24A, 24B in a second lateral direction 42B (e.g., opposite of the first lateral direction 42A). The wear block may be configured to engage a corresponding sway block, which is coupled to the frame 40 of the three-point hitch 14. During engagement with the sway block, the wear block of the second lower lift arm 24B may reduce or substantially block lateral movement (e.g., sway) of the lower lift arms 24A, 24B in the second lateral direction 42B. The actuator wedge of the second lower lift arm 24B may enable continuous or incremental adjustment of the wear block to accommodate a number of sway distances. For example, during a transport mode, the lower lift arms 24A, 24B may be raised up to lift a towed implement off the ground. In the transport mode, the wear block coupled to the second lower lift arm 24B may be adjusted to reduce lateral movement in the second lateral direction 42B or to substantially block lateral movement in the second lateral direction 42B of the lower lift arms 24A, 24B/implement hitch. During such transport, the user may set the wear block of the second lower lift arm 24B to establish reduced or substantially no sway. For example, the wear block of the second lower lift arm 24B may be moved into engagement with the corresponding sway block, and the engagement with the sway block may substantially block movement of the lower lift arms 24A, 24B in the second lateral direction 42B. Accordingly, the engagement of the wear block of the second lower lift arm 24B with the sway block may reduce or substantially block lateral movement in the second lateral direction 42B of the towed implement during transport. As such, lateral movement in the lateral directions 42A, 42B of the towed implement coupled to the three-point hitch 14 may be reduced or substantially blocked by the wear block assemblies of the lower lift arms 24A, 24B.

Additionally or alternatively, the three-point hitch 14 may enable a desired amount of sway for a towed implement when in use and pulling the towed implement along the ground. For example, the wear block assemblies 32 may enable the lower lift arms 24A, 24B to sway by up to 250 mm (e.g., up to 200 mm, up to 150 mm, up to 100 mm, up to 50 mm, and so forth). The wear block 34 may be adjusted to enable the desired sway distance. For example, the actuator wedge 36 may be moved to position the wear block 34 closer to the first lower lift arm 24A. The actuator wedge 36 may be moved until the wear block 34 is positioned to establish the target sway distance. As such, the lower lift arms 24A, 24B may move laterally in directions 42A, 42B until a wear block 34 coupled to a respective lower lift arm 24A, 24B engages a corresponding sway block 38, thereby blocking movement of the lower lift arms 24A, 24B/implement hitch in the respective lateral direction. Each lower lift arm 24A, 24B includes an opening configured to receive a corresponding lower hitch pin of the implement, and the upper link 26 includes an opening configured to receive a corresponding upper hitch pin of the implement.

In certain embodiments, the wear block 34 may be formed of a metal material, such as tempered ductile iron. For example, the wear block 34 may be formed by a casting process (e.g., without any machining of a wear surface of the wear block, without any machining of the wear block, etc.). Additionally or alternatively, a wear surface of the wear block 34 may be work hardened due to engagement and movement against the sway block 38. As such, the wear block 34 may have a longer lifespan due to the work hardening of the wear surface of the wear block 34. The sway block 38 may be formed of a metal material. In some embodiments, the sway block 38 may be formed of a harder material than that of the wear block 34. As such, the wear block 34 may wear down by a greater amount and/or may wear down quicker than the sway block 38. The wear block 34 may be easier to replace than the sway block 38 and may enable a user to quickly exchange the wear block 34 after a period of use and/or an amount of wear. The actuator wedge 36 may enable the wear block 34 to be adjusted as a wear surface of the wear block 34 wears down after a period of use and/or an amount of wear. For example, the actuator wedge 36 may be adjusted to maintain the sway distance between the sway block 38 and the wear block 34 and/or maintain contact between the sway block 38 and the wear block 34. The actuator wedge 36 may be formed of a metal material and may be formed of a harder material than that of the wear block 34. For example, the actuator wedge 36 and the sway block 38 may be formed of the same material. As described further herein, the actuator wedge 36 may enable adjustment of a position of the wear block 34 to adjust the sway distance of the lower lift arm 24 and the corresponding towed implement. In certain embodiments, a recess in the lower lift arm 24 may be larger than the actuator wedge 36 to enable a user to insert a tool into the recess. For example, a user may engage an end of the actuator wedge 36 with a tool to move the actuator wedge 36 relative to the lower lift arm 24 to adjust a position of the wear block 34. As such, by moving the actuator wedge 36, the user may adjust a position of the wear block 34 and may set the sway distance of the lower lift arm 24.

In some embodiments, any component of the wear block assembly 32 may be replaceable and serviceable. For example, a user may remove fasteners to service and/or replace the wear block 34 and/or the actuator wedge 36. In certain embodiments, the user may replace the wear block 34 after a substantial portion of the wear block 34 has worn away. For example, the user may replace the wear block 34 when the fasteners are within a threshold distance from the wear surface of the wear block 34. Additionally or alternatively, the user may replace the wear block 34 when a desired sway distance is no longer achievable due to the reduction in material on the wear surface of the wear block 34.

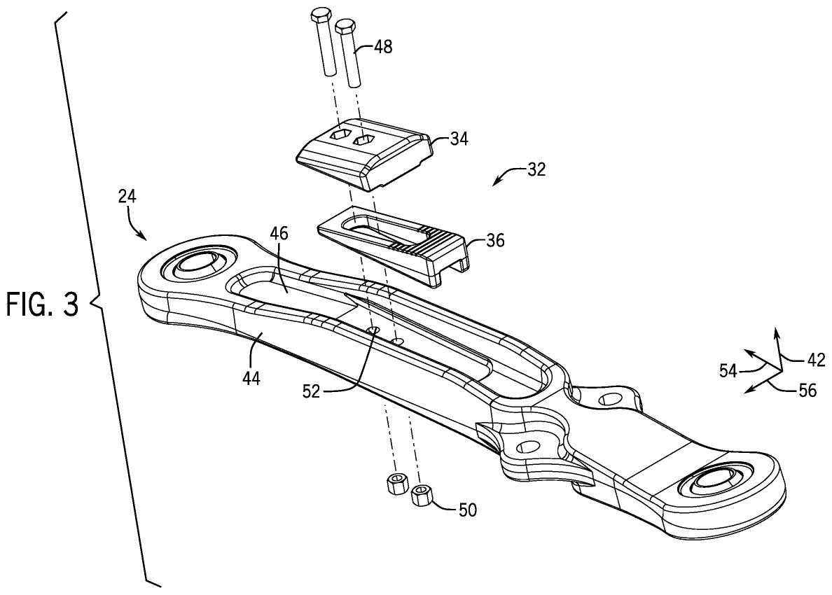

FIG. 3 is a perspective view of the lower lift arm 24 and the wear block assembly 32 of the three-point hitch of FIG. 2. The lower lift arm 24 includes a central body 44 having a recess 46 formed therein. The recess 46 may be formed and extend substantially along the central body 44 of the lower lift arm 24 (e.g., extend substantially along a longitudinal axis 54 of the lift arm 24). As discussed above, the wear block assembly 32 includes the wear block 34 and the actuator wedge 36. In some embodiments, the actuator wedge 36 may be at least partially disposed within the recess 46. As such, the central body 44 may prevent movement of the actuator wedge along a vertical axis 56. Additionally or alternatively, the wear block 34 may be partially disposed within the recess 46. Accordingly, the central body 44 may prevent movement of the wear block 34 along the vertical axis 56. The wear block 34 is movably coupled to the lower lift arm 24. For example, the wear block 34 may be coupled to the lower lift arm 24 via fasteners 48. Any suitable number of apertures 52 may be formed through the central body 44 of the lower lift arm 24, and the apertures 52 may receive the respective fasteners 48. As described herein, the wear block 34 may move relative to the lower lift arm 24 to adjust the sway distance of the lower lift arm 24. For example, the wear block 34 may move along a lateral axis 42 relative to the lower lift arm 24. The actuator wedge 36 may move relative to the lower lift arm 24 and may move within the recess 46 of the lower lift arm 24. For example, the actuator wedge 36 may move along the longitudinal axis 54 relative to the lower lift arm 24. The fasteners 48 may be loosened to enable the actuator wedge 36 to move relative to the lower lift arm 24 and may be tightened to secure the actuator wedge 36 and the wear block 34 in place. For example, the actuator wedge 36 may move along the longitudinal axis 54 relative to the lower lift arm 24 to adjust the lateral position of a wear surface of the wear block 34 along the lateral axis 42. The actuator wedge 36 may move in the direction of the longitudinal axis 54 relative to the lower lift arm 24 to adjust the lateral position of the wear surface of the wear block 34 in the direction of the lateral axis 42. Accordingly, the actuator wedge may move opposite the direction of the longitudinal axis 54 relative to the lower lift arm 24 to adjust the lateral position of the wear surface of the wear block 34 opposite the direction of the lateral axis 42. In certain embodiments, the fasteners 48 may be bolts having threads formed thereon and any number of nuts 50 may have corresponding threads formed thereon to threadedly couple to the fasteners 48. Additionally or alternatively, one or more of the fasteners 48 may be any other suitable type of fastener, such as a screw, a nail, an anchor, a rivet, and so forth.

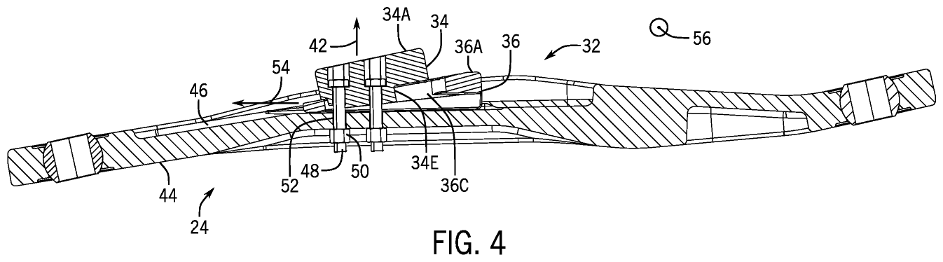

FIG. 4 is a cross-sectional view of the lower lift arm 24 and the wear block assembly 32 of FIG. 3. In the illustrated embodiment, the actuator wedge 36 is at least partially disposed within the recess 46 of the central body 44 of the lower lift arm 24. The actuator wedge 36 may be movable relative to the lower lift arm 24 in a single degree of freedom. For example, the actuator wedge 36 may be movable backwards and forwards within the recess along the longitudinal axis 54. Movement of the actuator wedge 36 may adjust the position of the wear block 34 along the lateral axis 42, thereby increasing or decreasing the sway distance of the lower lift arm 24. For example, moving the actuator wedge 36 along the longitudinal axis 54 causes the actuator wedge 36 to drive the wear block 34 to move. In response to movement of the actuator wedge 36 along the longitudinal axis 54, an upper surface 36A of the actuator wedge 36 may drive the wear block 34 to move away from the lower lift arm 24 along the lateral axis 42.

The fasteners 48 block movement of the wear block 34 along the longitudinal axis 54 of the lower lift arm 24 due to the fasteners 48 being disposed through the apertures 52 of the central body 44. As a result, the position of the wear block 34 relative to the lower lift arm 24 along the longitudinal axis 54 remains substantially constant as the wear block 34 moves along the lateral axis 42. Accordingly, the wear block 34 may move substantially in a single degree of freedom substantially normal to a surface of the lower lift arm 24, such as along the lateral axis 54. By moving substantially only in a single degree of freedom and blocking rotation of the wear block 34, only the wear surface 34A of the wear block 34 may engage and wear against the sway block 38. For example, the tab 34E of the wear block 34 may be at least partially disposed in the slot 36C of the actuator wedge 36 and the tab 34E may engage walls of the slot 36C to prevent rotation of the wear block 34 about the lateral axis 42 and/or the longitudinal axis 54 relative to the actuator wedge 36. Additionally, because the position of the wear block along the longitudinal axis relative to the lower lift arm remains substantially constant, the bending moment placed on the lower lift arm 24 by engagement of the wear block 34 with the sway block 38 may substantially remain in a target position along the longitudinal extent of the lower lift arm. As such, a lifespan of the lower lift arm 24 may be increased because the target position of the lower lift arm 24 is configured to resist the bending moment. In certain embodiments, the fasteners 48 may be cast into the wear block 34. For example, the wear block 34 and fasteners 48 may be a single component. In such embodiments, the heads of the fasteners and the apertures in the wear block may be omitted. Additionally or alternatively, a portion of the wear block 34 may be disposed in the actuator wedge 36. In the illustrated embodiment, the actuator wedge 36 has a slot 36C formed therethrough, and the slot is configured to receive a portion (e.g., a tab 34E) of the wear block 34. The fasteners 48 may be disposed through the slot and may extend through a cross-beam of the lower lift arm 24 (e.g., through the apertures 52 of the lower lift arm 24). In certain embodiments, the slot 36C may define a range of movement for the actuator wedge 36 along the longitudinal axis 54. For example, the actuator wedge 36 may move in a first longitudinal direction (e.g., in the direction of the longitudinal axis 54) relative to the lower lift arm 24 until one end of the slot 36C engages the tab 34E. Accordingly, the actuator wedge 36 may move in a second longitudinal direction (e.g., in a direction opposite of the longitudinal axis 54) relative to the lower lift arm 24 until an opposite end of the slot 36C engages the tab 34E.

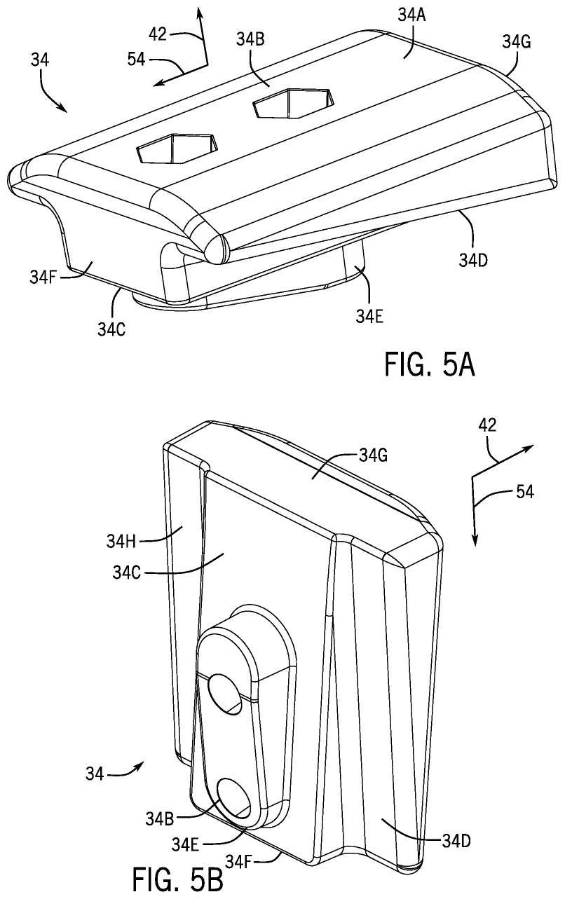

FIG. 5A is a top perspective view of the wear block 34 of the wear block assembly of FIG. 2. In the illustrated embodiment, the wear block 34 includes a wear surface 34A. The wear surface 34A is configured to engage a respective sway block, such as the sway block of FIG. 2, to reduce and/or substantially block lateral movement of the lower lift arm 24. In certain embodiments, the wear block 34 may include any suitable number of apertures 34B formed therethrough. For example, the apertures 34B may extend from the wear surface 34A to a contact surface 34C of the wear block 34. The apertures 34B are configured to receive respective fasteners, such as the fasteners of FIG. 3, to couple the wear block 34 to the lower lift arm 24. Additionally or alternatively, at least one fastener 48 may be cast with the wear block 34, such that the fastener extends from the bottom surface. In certain embodiments, the wear surface 34A may be a contoured surface, such as an arcuate surface. The wear surface 34A of the wear block 34 may provide a continuous area for engagement with the sway block 36. The wear surface 34A of the wear block 34 may wear down over time and/or due to repeated use. As such, the wear surface 34A may wear away and the wear block 34 may be adjusted in a first lateral direction to accommodate for the reduction in material due to the wear. For example, the wear surface 34A may be moved along the lateral axis 42 and in the direction of the lateral axis 42 relative to the lower lift arm to accommodate for the reduction in material. Additionally or alternatively, the wear surface 34A may be adjusted in a second lateral direction to increase the sway distance. For example, the wear surface 34A may be moved along the lateral axis 42 and in a direction opposite of the lateral axis 42 to increase the sway distance.

FIG. 5B is a bottom perspective view of the wear block 34 of the wear block assembly of FIG. 2. In the illustrated embodiment, the apertures 34B extend to the contact surface 34C of the wear block 34. The contact surface 34C may be a tapered surface and may include a corresponding slope. The slope of the contact surface 34C may be substantially equal to a slope of the actuator wedge. The contact surface 34C may contact and may engage a portion of the actuator wedge, thereby enabling the actuator wedge to drive the wear block 34 to move along the lateral axis 42 to adjust the sway distance of the lower lift arm. For example, the wear block 34 may move in a first lateral direction (e.g., in the direction of the lateral axis 42) to decrease the sway distance of the lower lift arm and the wear block 34 may move in a second lateral direction (e.g., opposite the direction of the lateral axis 42) to increase the sway distance of the lower lift arm. The wear block 34 may also include any number of tapered surfaces, such as tapered surfaces 34D, 34H. The tapered surfaces 34D, 34H may include a corresponding slope and the slopes of the tapered surfaces 34D, 34H may be substantially equal. In some embodiments, the slopes of the tapered surfaces 34D, 34H may be equal. The tapered surfaces 34D, 34H may extend from a front end 34F to a back end 34G of the wear block 34 along the longitudinal axis 54, and the tapered surfaces 34D, 34H may increase in thickness along a direction from the front end 34F to the back end 34G. In the illustrated embodiment, the wear block 34 includes a tab 34E. The tab 34E may be received by the slot of the actuator wedge and may control movement of the actuator wedge relative to the wear block. For example, the tab 34E may enable the actuator wedge to move along a selected/target range of motion along the longitudinal axis of the lower lift arm, thereby controlling a maximum lateral position and a minimum lateral position of the wedge block relative to the lower lift arm. Additionally or alternatively, the tab 34E may block rotation of the wear block 34 about the lateral axis 42 relative to the actuator wedge 36. For example, the tab 34E may be at least partially disposed in the slot 36C of the actuator wedge and the tab 34E may engage one or more walls of the slot 36C to prevent rotation of the wear block 34 about the lateral axis 42 relative to the actuator wedge 36. The tab 34E and the slot 36C may also prevent movement of the wear block along the vertical axis 56 relative to the actuator wedge 36.

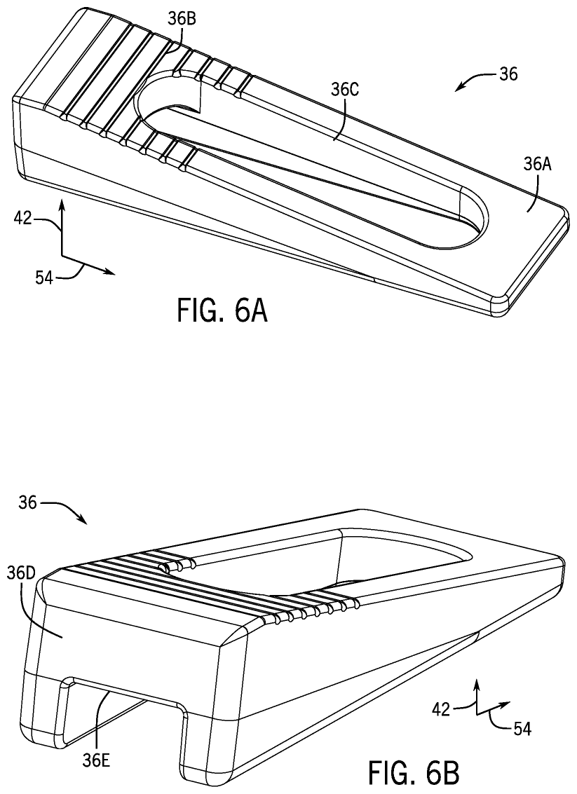

FIG. 6A is a top perspective view of the actuator wedge 36 of the wear block assembly of FIG. 2. In the illustrated embodiment, the actuator wedge includes the upper surface 36A. In the illustrated embodiment, the upper surface 36A is a tapered surface. For example, the upper surface 36A may mirror the tapered surface of the contact surface of the wear block (e.g., the slope of the upper surface 36A of the actuator wedge 36 may be substantially equal to the slope of the contact surface of the wear block). The upper surface 36A is configured to engage the contact surface of the wear block, and the actuator wedge 36 is configured to move the wear block due to the engagement. For example, the wear block 36 may move along the longitudinal axis 54 relative to the lower lift arm 24, as described herein. The upper surface 36A of the actuator wedge 36 and corresponding contact surface of the wear block may cause the wear block to move in a first lateral direction (e.g., away from the lower lift arm in the direction of the lateral axis 42) in response to movement of the actuator wedge 36 in a first longitudinal direction (e.g., the direction of the longitudinal axis 54). Accordingly, the sway distance may be reduced. As the wear block 36 wears down due to repeated use, the actuator wedge 36 may be moved to adjust the position of the wear block to accommodate for the reduction in material. Additionally or alternatively, the upper surface 36A of the actuator wedge 36 and corresponding contact surface of the wear block may cause the wear block to move in a second lateral direction (e.g., towards the lower lift arm opposite the direction of the lateral axis 42) in response to movement of the actuator wedge 36 in a second longitudinal direction (e.g., opposite the direction of the lateral axis 42).

In certain embodiments, the upper surface 36A may have any suitable number of indicators 36B formed thereon. For example, the indicators 36B may be a set of grooves formed in the upper surface 36A. Additionally or alternatively, the indicators 36B may be placed on the upper surface 36A in any suitable manner, such as painted on the upper surface 36A, may be raised ridges on the supper surface 36A, and so forth. The indicators 36B may provide an indication of the sway distance of the lower lift arm. For example, the number of indicators 36B that are uncovered (e.g., visible to an operator) may provide an indication of the sway distance. As such, a user may visually inspect the indicators 36B to determine and/or establish a desired sway distance for a towed implement. The indicators 36B may indicate the sway distance and may assist a user in centering the implement hitch. For example, the user may visually inspect the indicators 36B on each actuator wedge 36, which is coupled to a respective lower lift arm, to determine whether each wear block is positioned at the same lateral position relative to the respective lower lift arm. As such, if the number of visible indicators 36B is different, the user may adjust one or more wear block assemblies until the number of visible indicators 36B are the same for each wear block assembly. Additionally or alternatively, the indicators 36B may enable a user to determine when to replace the wear block. For example, if the actuator wedge 36 is moved until all indicators 36B are covered by the wear block, and the wear surface of the wear block 34 is not at a desired lateral position (e.g., which establishes a target sway distance), then the wear surface of the wear block may be worn beyond a threshold amount. As such, the user may remove the fasteners coupling the wear block to the respective lower lift arm and may decouple the wear block from the respective lower lift arm. The user may then replace the worn wear block with a new wear block and may use the fasteners to couple the new wear block to the respective lower lift arm.

In the illustrated embodiment, the actuator wedge 36 includes a slot 36C formed therethrough. The slot 36C is formed through the upper surface 36A. In some embodiments, the slot 36C is configured to receive a portion of the wear block 34, such as the tab. For example, the tab of the wear block may be at least partially disposed within the slot 36C when the wear block assembly 32 is coupled to the respective lower lift arm. The slot 36C may establish a range of motion for the actuator wedge 36 along the longitudinal axis 54 of the lower lift arm 24. As previously discussed, the fasteners are configured to couple the wear block to the respective lower lift arm, such that movement of the wear block along the longitudinal axis of the lower lift arm is blocked. The fasteners 48 may selectively enable movement of the wear block 34 away from the lower lift arm 24 along the first lateral direction (e.g., by loosening the fasteners). Furthermore, because the tab of the wear block is disposed in the slot 36C, the tab may block movement of the actuator wedge 36 outside of a range of motion along the longitudinal axis 54, which is established by the slot 36C. For example, the actuator wedge 36 may be moved along the longitudinal axis of the lower lift arm 24. The first end and the second end of the slot 36C may engage corresponding ends of the tab of the wear block to block movement of the actuator wedge 36 along the longitudinal axis of the lower lift arm. Additionally or alternatively, the slot 36C may be formed only partially through the upper surface 36A of the actuator wedge 36.

FIG. 6B is a rear perspective view of the actuator wedge 36 of the wear block assembly 32 of FIG. 2. The actuator wedge 36 may include an end having a flat surface 36D. The flat surface 36D may be impacted by a tool, such as a hammer, to move the actuator wedge 36, thereby adjusting a position of the wear block along the lateral axis 42. In certain embodiments, an opening 36E may be formed at the flat surface 36D. For example, the opening 36E may be a rectangular cutout and may extend to the flat surface 36D. The opening 36E of the actuator wedge 36 may receive a tool for moving the actuator wedge 36. For example, the opening 36E may form a lip of the actuator wedge 36, and a tool, such as a prybar, may engage the lip to adjust the longitudinal position of the actuator wedge 36. Additionally or alternatively, the opening 36E may enable material (e.g., debris) to be cleaned or washed out of an interior of the actuator wedge 36.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A wear block assembly for a three-point hitch, comprising:
an actuator wedge configured to move along a longitudinal axis relative to a lower lift arm of the three-point hitch, wherein the actuator wedge comprises a tapered surface; and
a wear block configured to move along a lateral axis relative to the lower lift arm, wherein the wear block comprises:
a wear surface configured to engage a sway block of the three-point hitch; and
a contact surface configured to engage the tapered surface of the actuator wedge, wherein the actuator wedge is configured to drive the wear block to move in a first direction along the lateral axis in response to movement of the actuator wedge in a second direction along the longitudinal axis.

2. The wear block assembly of claim 1, wherein the actuator wedge comprises a slot formed through the tapered surface.

3. The wear block assembly of claim 2, wherein the wear block comprises a tab.

4. The wear block assembly of claim 3, wherein the tab is configured to be at least partially disposed in the slot of the actuator wedge.

5. The wear block assembly of claim 4, wherein the tab prevents rotation of the wear block about the lateral axis relative to the actuator wedge.

6. The wear block assembly of claim 1, wherein the contact surface is tapered, and a first slope of the tapered surface is substantially equal to a second slope of the contact surface.

7. The wear block assembly of claim 1, wherein a plurality of indicators are formed on the tapered surface.

8. A wear block assembly for a three-point hitch, comprising:
an actuator wedge configured to move along a longitudinal axis relative to a lower lift arm of the three-point hitch, the actuator wedge comprising a slot formed through a first surface of the actuator wedge; and
a wear block configured to move along a lateral axis relative to the lower lift arm, the wear block comprising a tab extending away from a first surface of the wear block, wherein the slot is configured to receive a portion of the tab to couple the wear block and the actuator wedge, and wherein movement of the actuator wedge in the first direction is configured to move the wear block in the second direction.

9. The wear block assembly of claim 8, wherein the wear block is formed of a ductile iron material.

10. The wear block assembly of claim 8, wherein the actuator wedge comprises a plurality of grooves formed on the first surface of the actuator wedge.

11. The wear block assembly of claim 8, wherein the first surface of the actuator wedge is tapered.

12. The wear block assembly of claim 8, wherein the wear block comprises at least one aperture formed therethrough, wherein the at least one aperture is configured to receive a fastener to couple the wear block to the lower lift arm.

13. The wear block assembly of claim 8, comprising one or more fasteners configured to couple the wear block to the lower lift arm.

14. A wear block assembly for a three-point hitch, comprising:
an actuator wedge configured to move along a longitudinal axis relative to a lower lift arm of the three-point hitch; and
a wear block configured to move along a lateral axis relative to the lower lift arm, wherein the actuator wedge is configured to drive the wear block to move in a first direction along the lateral axis in response to movement of the actuator wedge in a second direction along the longitudinal axis.

15. The wear block assembly of claim 14, wherein the wear block is formed of a ductile iron material.

16. The wear block assembly of claim 14, comprising at least one fastener configured to removably couple the wear block to the lower lift arm.

17. The wear block assembly of claim 16, wherein the at least one fastener is configured to removably couple the actuator wedge to the lower lift arm.

18. The wear block assembly of claim 16, wherein the wear block is configured to be partially disposed within a recess of the lower lift arm.

19. The wear block assembly of claim 18, wherein the actuator wedge is configured to be at least partially disposed within the recess of the lower lift arm.

20. The wear block assembly of claim 19, wherein the actuator wedge is configured to move along the longitudinal axis within the recess of the lower lift arm.
